(19) United States
(12) Patent Application Publication
(10) Pub. No.: US 2012/0328844 A1
(43) Pub. Date: Dec. 27, 2012

(54) Spacer for Filtration Devices

(75) Inventors: Alex Zounek, Wiesbaden (DE); Ulrich Meyer-Blumenroth, Idstein-Woersdorf (DE)

(73) Assignee: MN BETEILIGUNGS GMBH, Grafenhausen (DE)

(21) Appl. No.: 13/582,563

(22) PCT Filed: Mar. 2, 2011
(86) PCT No.: PCT/DE11/00230

§ 371 Date: Sep. 4, 2012

(30) Foreign Application Priority Data
Mar. 8, 2010 (DE) 10 2010 010 591.0

(51) Int. Cl. B01D 65/00; B01D 61/28; B01D 61/18; B29C 59/04; B01D 61/08

(52) U.S. Cl. 428/174; 264/293; 55/482; 210/335

(57) ABSTRACT

A spacer for devices for gas separation, reverse osmosis, forward osmosis, dialysis, micro-, ultra, or nano-filtration formed from a planar material which has a plurality of convex support elements having a footprint of 0.03 to 600 mm² on one or both surfaces. The support elements are arranged on the planar material in a periodic pattern having a unit cell containing 2 to 100000 support elements. The unit cell has a surface coverage of 0.1 to 20%.

The present invention relates to a spacer for devices for gas separation, reverse osmosis, forward osmosis, dialysis, micro-, ultra- or nanofiltration, comprising a flat material which has support elements on one or both sides.

In a multiplicity of industrial and municipal applications, such as wastewater purification and seawater desalination, membrane-supported filtration processes have been used for decades, in particular crossflow filtration. In this case a fluid to be purified, hereinafter termed feed, flows over porous membranes constructed in sheet form tangentially to the membrane surface. The pore size of the membranes, according to the application, is in the range from about 10 nanometers to some micrometers. The volume of feed that has flowed over, usually termed flow, is separated by the membrane from a permeate chamber. Between flow and permeate chamber, a differential pressure of about 0.1 bar to 100 bar is applied which effects a mass transport from flow to the permeate chamber, wherein permeate (or filtrate) passes into the permeate chamber.

The membrane is customarily formed as a two-layer composite of a support nonwoven and a porous membrane layer. Preferably, the porous membrane layer consists of polyethersulfone, polysulfone, polyacrylonitrile, polyvinylidene fluoride, polyamide, polyether imide, cellulose acetate, regenerated cellulose, polyolefin or fluoropolymer. The porous membrane layer is produced, for example, by coating a nonwoven or woven fabric with polymer solution and precipitating out the polymer in a subsequent phase inversion step. Alternatively thereto, a polymer film is stretched in a suitable manner, wherein pores are formed in the polymer film. The stretched polymer film is then laminated onto a support nonwoven for mechanical stabilization. Filtration membranes produced according to these methods are commercially available, e.g. under the name NADIR® membranes (MICRODYN-NADIR GmbH, Wiesbaden) or Celgard® flat sheet membranes (Celgard Inc., Charlotte, N.C., USA).

Components contained in the feed, the diameter of which is too great to pass through the membrane pores, are retained on the membrane surface and remain in part adhering. In crossflow filtration feed is permanently passed over the membrane surface in order to transport away the retained components (retentate) from the membrane surface. In this manner, a continuous filtration operation with constant permeate flux is possible. The crossflow mode of operation results in the typical structure of membrane modules having three connections for feed, retentate and permeate.

The permeate chamber is bordered by two separate membranes or by two partial surfaces of a one-piece membrane. Between the two membranes or partial surfaces, a porous permeate spacer is arranged which firstly serves as support structure for the sensitive membranes which are loaded by a transmembrane differential pressure of up to 100 bar, and secondly provides passages through which the permeate flows off along the insides of the membranes/partial pieces. In order to minimize the energy demand necessary for removing the permeate, permeate spacers having a resistance to flow as low as possible are used. Thus permeate spacers that are usual in the prior art have, for example, surfaces having a multiplicity of channels running in parallel in the direction of the pressure drop and are separated by bridges, wherein the bridges serve as supports for the membranes. In order to decrease the resistance to flow, neither can the bridge width be decreased as desired nor can the bridge spacing be increased as desired, because otherwise the support of the membranes is insufficient and the membranes bend under the high transmembrane differential pressure and/or are mechanically damaged.

Filtration systems that are usual in the prior art are made up of flat filter modules or spirally wound filters.

In flat filter modules, a multiplicity of planar filter elements are arranged parallel to one another in a stack. Between each two adjacent filter elements there is a spacer—hereinafter termed feed spacer. The feed spacer is usually of a net-like structure and modifies the flow of the feed over the membranes. In order to achieve a compact structure and efficient overflow of the membranes, the filter elements and feed spacers are constructed to be as thin as possible. The feed spacers usually used consist of a net of two layers of filaments arranged crosswise. The filaments are made of a polymeric material such as nylon or polypropylene and have a diameter in the range from 0.5 to 1.5 mm. Preferably, what is termed a diamond spacer is used, in which the polymeric net has lozenge-shaped meshes and the filaments run slanted at an angle of about 45° to the overflow direction of the feed. The volumetric void fraction of feed spacers which substantially corresponds to the product of open mesh area and filament diameter, based on the product of total area and filament diameter, is typically 70 to 90%. In the prior art, in addition, a multiplicity of further feed spacers are known which are constructed as two-dimensional shaped bodies of polymeric, metallic or ceramic materials. Some of the known feed spacers are equipped with flow-guiding structures having complex geometry, for example zigzag or spiral geometry.

Spirally wound filters are usually produced by placing four flexible webs of a first membrane, a feed spacer, a second membrane and a permeate spacer one above the other and spirally winding them around a cylindrical tube under the action of a high tensile force. In order to seal off flow and permeate chamber from one another, depending on the configuration of the spirally wound filter, the membranes are sealed fluid-tightly by the permeate spacer on two or more edge sides and optionally connected to the centrally arranged tube on a further edge side, in order to create a passage for draining off permeate. Alternatively, a spirally wound filter can be configured in such a manner that permeate is withdrawn over one or both longitudinal edges of the membranes, i.e. on the ends of the spirally wound filter and feed is fed via the central tube.

The patent publication US 20080290031 A1 describes a feed spacer which is suitable for spirally wound filters and flat filter modules. The feed spacer consists of a flat material which has protecting elements on both sides. The protecting elements are variously formed, in particular they have a spherical or channel-like shape. The protecting elements are arranged on the flat material in a regular pattern of lines parallel to one another.

The feed spacer determines the course of the flow of the feed (crossflow) on the membrane surface. For the mass transport and the filtration performance, detachment or mixing of the retentate enriched in what termed the polarization layer with fresh feed is essential. Accordingly, the feed spacer affects the efficiency and economics of a filtration device in a definitive manner. Therefore, in industry and research, great efforts are made to develop novel feed spacers which increase the mass transport on the membrane surface and at the same time decrease the resistance to flow and therefore the pressure drop between flow and retentate drainage. In particular, the last point is becoming increasingly important, because thereby the energy requirement for operating a filtration device is reduced. A substantial part of the operating costs for filtration is due to the energy for generating the feed overflow. Depending on the flow velocity and geometry of the feed spacer, in the crossflow, vortices and also backed-up zones and dead zones form. These disturbances of the crossflow are caused in the net-like feed spacers usual in the prior art especially by filaments running slanted or perpendicularly to the direction of flow. Vortices increase the resistance to flow, whereas in backed-up zones and dead zones the mass transport is impeded and the filtration efficiency is decreased thereby. In addition to the energy and filtration efficiency, other criteria play a role, such as the cleaning of the filter modules and therefore the mechanical stability of the feed spacer.

The object of the present invention is to provide a spacer for devices for gas separation, reverse osmosis, forward osmosis, dialysis, micro-, ultra- or nanofiltration, which has a good filtration efficiency with at the same time low resistance to flow. When used as a permeate spacer, the spacer in addition should ensure uniform mechanical support of the filtration membranes without localized overloading. In addition, the spacer should be mechanically robust and cheap to produce. This object is achieved by a spacer comprising a flat material which has a multiplicity of convex support elements having a base area of 0.03 to 600 mm² on one or both surfaces and which are arranged on the flat material in a pattern having one or more periodically repeating unit cells containing 2 to 100 000 support elements having a surface coverage of 0.1 to 20%.

Developments of the spacer according to the invention are characterized in that:
the surface coverage of the support elements on the flat material is in the range from 0.1 to 10%, preferably 1 to 8%, and in particular 1 to 5%;
the unit cell contains 3 to 10 000, preferably 10 to 1000, and in particular 20 to 100, support elements;
any straight line which runs in a predetermined direction or axis on one or both surfaces of the flat material intersects the base area of at least one support element on a section having a length of 2 to 1000 mm;
the support elements are arranged in a pattern having one or more periodically repeating parallelogram-shaped or rectangular unit cells having a first and second side D and L which, independently of one another, have a length of 2 to 1000 mm, wherein the unit cell contains 2 to 100 000 support elements, and N support elements where N is integral and 2≦N≦1000, preferably 3≦N≦1000, in particular 10≦N≦200, and particularly preferably 20≦N≦100, based on the origin of the unit cell and in the direction of the side D are arranged at a spacing of greater than D·(2·j−1)/(2·N)−0.1·D/N and less than D·(2·j−1)/(2·N)+0.1·D/N where j is integral and 1≦j≦N and each value j=1, . . . , N occurs exactly once;
the N support elements based on the origin of the unit cell and in the direction of the side L are arranged at a spacing of greater than L·(2·i−1)/(2·M)−0.1·L/M and less than L·(2·i−1)/(2·M)+0.1·L/M where M, i are integral, 2≦M≦1000 and 1≦i≦M, where M is preferably equal to N (M=N);
each value i occurs exactly once;
for at least two of the N support elements, the values i and j are different from one another (i≠j) and for at least two support elements the sum i+j is different from N+1 (i+j≠N+1), and preferably for at least one support element the values i and j are equal (i=j) and for at least one support element the sum of the values i and j is equal to N+1 (i+j=N+1);
the support elements have a dome shape;
the support elements, in the direction of the side D, have a width at half maximum W2 and W3 which is in the range from 0.2·D/N to 1.2·D/N, preferably 0.4·D/N to 1.0·D/N, and in particular 0.4 to 0.8·D/N, or that the support elements, in the direction of the side D, have a width at half maximum W2 and W3 of 0.3 to 10 mm;
the support elements have a height H from 0.1 to 4 mm, in particular 0.6 to 2.0 mm, in each case based on a base area of the spacer;
the support elements have passages having a cross section which is arranged substantially perpendicularly to the predetermined axis and the passages join the opposite sides of the spacer;
the spacer is formed to be one piece, wherein, preferably, the flat material is a film or a knitted fabric made of one or more polymeric, textile or metallic materials, in particular of polyvinylsiloxane and has a thickness of 0.1 to 2 mm; and
the spacer has a hydrophobic coating.

The spacer according to the invention is used as feed spacer in the flow and/or as permeate spacer in the permeate chamber of a filtration device. In addition it is provided that the spacer forms an integral component of a filtration membrane. Depending on whether it is used as a feed spacer and/or permeate spacer, for this purpose the front side, i.e. a polymeric membrane layer deposited by phase inversion, or a stretched polymer film and/or the rear side, i.e. the support nonwoven or support woven fabric of the filtration membrane is structured.

According to the invention, the expression “unit cell” comprises any polygon that makes possible complete tessellation of the surface, such as any desired triangles and quadrangles, parallelograms, rectangles or regular hexagons. In the context of the invention, unit cells having a parallelogram or rectangular shape are preferred.

The pattern in which the support elements are arranged on the flat material can consist of only one unit cell or a subregion of a unit cell. This is the case, for example, when a large unit cell having side lengths of 100 to 1000 mm is chosen and the dimensions or side lengths of the filters are 100 mm or less. The core of the invention represents the above described pattern, according to which the support elements are arranged on the flat material in such a manner that any straight line which runs in a predetermined direction or axis on one or both surfaces of the flat material intersects the base area of at least one support element on a section having a length of 2 to 1000 mm. The pattern according to the invention ensures that a fluid flowing in the predetermined direction tangentially to the surface of the flat material—whether it be a gas or a liquid—is deflected in a defined manner.

Preferably, however, the pattern is periodic and comprises a plurality of repeating unit cells different from one another in one or in two dimensions. In an edge region of the spacer, or along a cut edge of the flat material, the pattern can contain partial surfaces of unit cells, for example one half of a unit cell. For producing the spacers according to the invention, preferably, continuous processes such as embossing or pressure are used which make use of rotating rollers and generate periodic patterns in the running or machine direction.

The surface coverage designates the part of the surface of the unit cell which is covered by support elements. The surface coverage corresponds to the quotient of (number of support elements×mean base area of the support elements)/(area of the unit cell). Expediently, all support elements have the same shape and base area. Where this is not the case, for example owing to design-related conditions or fluctuations due to method of fabrication, in the above relationship (quotient), a “mean base area” determined by measurement is used.

Preferably, the support elements in the unit cell are arranged in such a manner that any straight line which runs in a predetermined direction or axis on one or both surfaces of the flat material intersects the base area of at least one support element on a section having a length of 2 to 1000 mm. Accordingly, each stream line of a fluid that flows over the surface of the flat material in the predetermined direction is deflected at least once.

According to the invention, the expression “dome-shaped” is taken to mean a solid or shell-type support element projecting from the surface of the flat material, the surface of which has approximately the shape of a segment of a sphere or of an ellipsoid of rotation.

The predetermined direction or axis runs parallel to the surface of the flat material and, on installation of the spacer into a filter module, is directed substantially parallel to the flow axis of the flow (i.e. parallel to the flow direction of the feed or parallel to the crossflow) and/or parallel to the flow axis of the permeate chamber. For economic production of the spacer according to the invention, preferably a band-shaped flat material, in particular a polymer film is used. In this case the predetermined axis corresponds to the longitudinal axis of the band. For processing, the band-shaped flat material is expediently provided in the form of a roll.

The number of support elements in the unit cell is 2 to 100 000, where N of the support elements (where 2≦N≦1000) are arranged in such a manner that in each case two of the N support elements, in the direction of the side D, have the same spacing D/N from one another. According to the invention, the number N of the support elements arranged in the unit cell equidistantly in the direction of the side D explicitly take each value between 2 and 1000, i.e. N=2, 3, 4, 5, 6, 7, 8, 9, 10, 11, 12, 13, 14, 15, 16, 17, 18, 19 or 20; N=21, . . . , 30; N=31, . . . , 40 etc.

The further support elements can be arranged at any desired position in the unit cell. However, according to the invention, spacers having the lowest possible surface coverage are preferred, in which the unit cell, in addition to the N support elements arranged equidistantly in the direction of the side D, does not contain any further support elements.

In order that the spacer according to the invention performs its function, in particular the flow deflection, it is not necessary that in each case two of the N support elements are positioned exactly at a spacing of D/N from one another in the unit cell in the direction of the side D. Rather, the flow deflection according to the invention is also performed when the N support elements are arranged in the direction of the side D in spacings of greater than D·(2·j−1)/(2·N)−0.1·D/N and less than D·(2·j−1)/(2·N)+0.1·D/N where j is integral and 1≦j≦N, wherein each value j=1, . . . , N occurs exactly once. Because the support elements, inter alia in the direction of the side D, have a width different from zero a positioning of the respective support element differing from a value of up to ±0.1·D/N from the exact value D·(2·j−1)/(2·N) is permissible and included according to the invention. Apart from the flow deflection, in addition, it is necessary to take into account the fact that films, nonwovens and woven fabrics made of polymeric, textile or else metallic materials, from which the spacers according to the invention are preferably produced, are deformed in the production process, wherein, owing to manufacturing tolerances, small deviations from a mathematically predetermined theoretical shape are unavoidable.

The above details with respect to flow deflection and manufacturing tolerances apply equally to the positioning of the N support elements in the direction of the side L. Based on the origin of the unit cell, the N support elements in the direction of the side L are preferably arranged in a spacing of greater than L·(2·i−1)/(2·M)−0.1·L/M and less than L·(2·i−1)/(2·M)+0.1·L/M where M, i are integral, 2≦M≦1000 and 1≦i≦M, wherein, particular, M is equal to N (M=N). Accordingly, a positioning of the respective support element in the direction of the side L in a spacing of exactly L·(2·i−1)/(2·M) based on the origin of the unit cell is sought after, but is not absolutely necessary.

In addition, the invention has the object of providing a filtration device having increased filtration efficiency and low energy demand. This object is achieved by a device for gas separation, reverse osmosis, forward osmosis, dialysis, micro-, ultra- or nanofiltration, comprising filtration membranes and one or more of the above described spacers arranged in the flow and/or the permeate chamber of the device. Preferably, the side L of the unit cell of the spacers is oriented substantially parallel to a flow axis of the flow and/or of the permeate chamber. A preferred embodiment of the filtration device according to the invention is characterized in that the spacer is an integral component of the filtration membranes.

The invention in addition has the object of providing a method for producing a spacer having the above-mentioned features. This object is achieved by a method in which, in a band-shaped flat material made of a metallic, polymeric or textile material, using at least one embossing roller, support elements are formed and the at least one embossing roller has shaping embossing elements which are arranged in a periodical pattern having a unit cell containing 2 to 100 000 embossing elements and a surface coverage of 0.1 to 20% on the surface of the embossing roller. Preferably, the embossing elements are arranged in a periodic pattern having a parallelogram-shaped or rectangular unit cell having a first and second side D and L which, independently of one another, have a length of 2 to 1000 mm, wherein the unit cell contains 2 to 100 000 embossing elements, and N embossing elements where N is integral and 2≦N≦1000, preferably 3≦N≦1000, in particular 10≦N≦200, and particularly preferably 20≦N≦100, based on the origin of the unit cell and in the direction of the side D are arranged at a spacing of D·(2·j−1)/2·N) where j is integral and 1≦j≦N and each value j=1, . . . , N occurs exactly once.

The invention will be described in more detail hereinafter with reference to drawings (figures). In the figures:

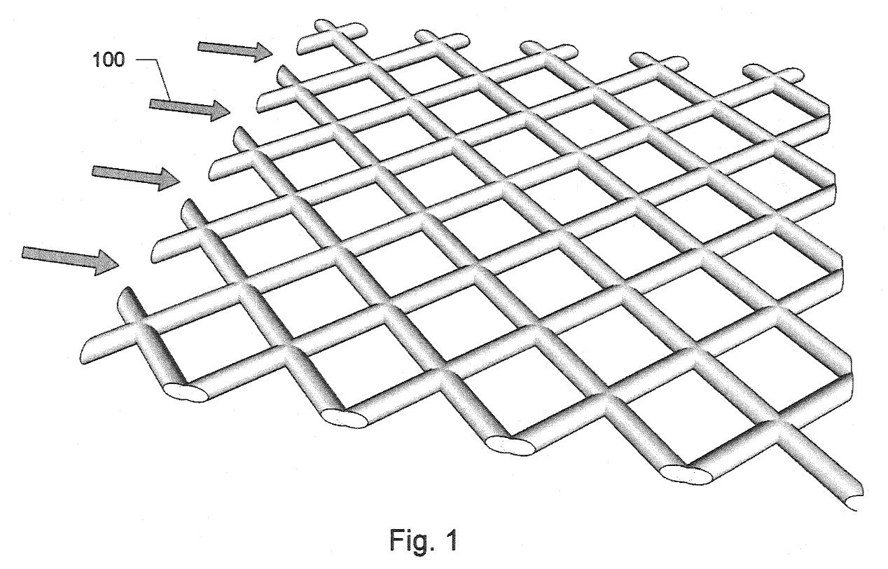

FIG. 1 shows a diamond spacer of the prior art;

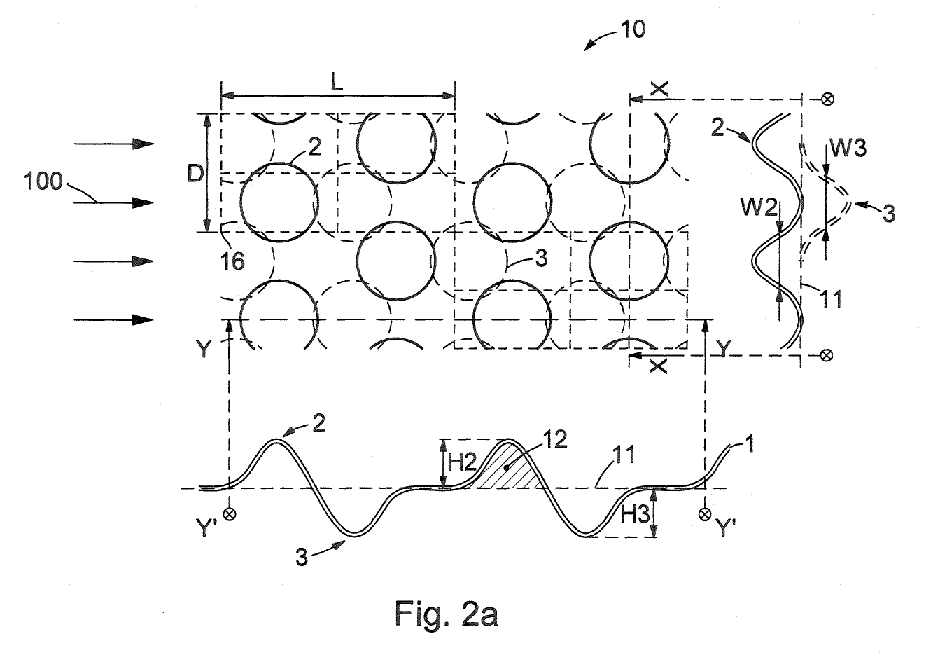

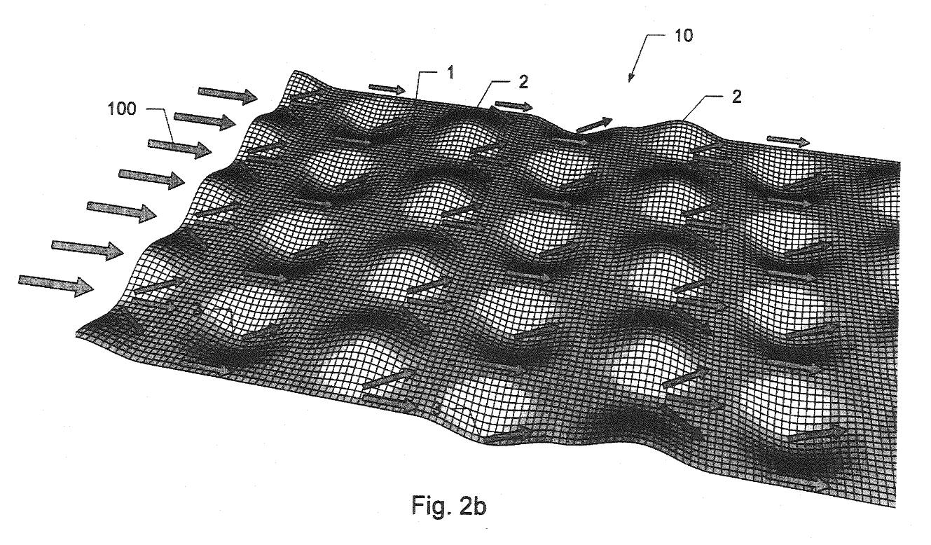

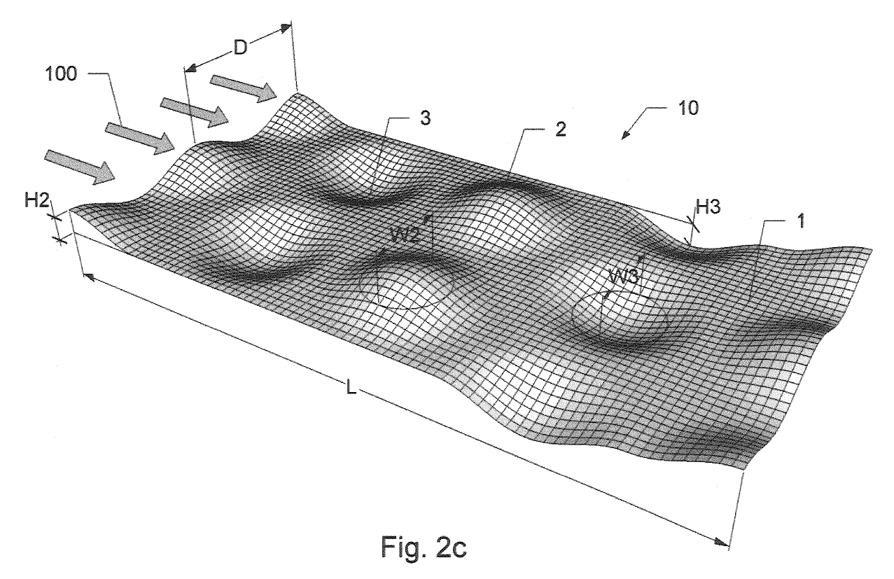

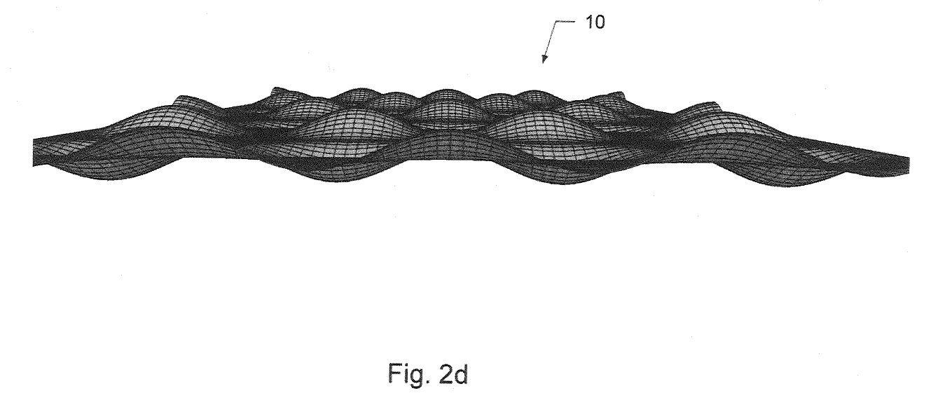

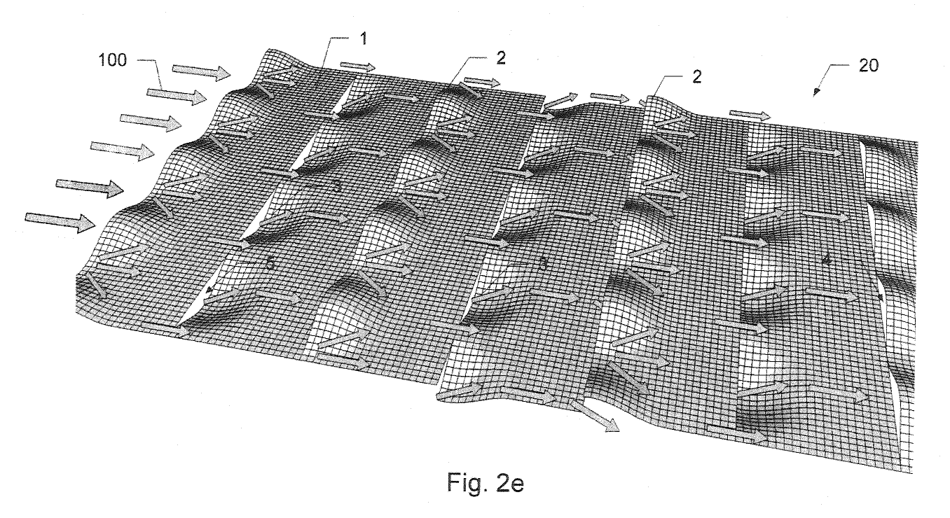

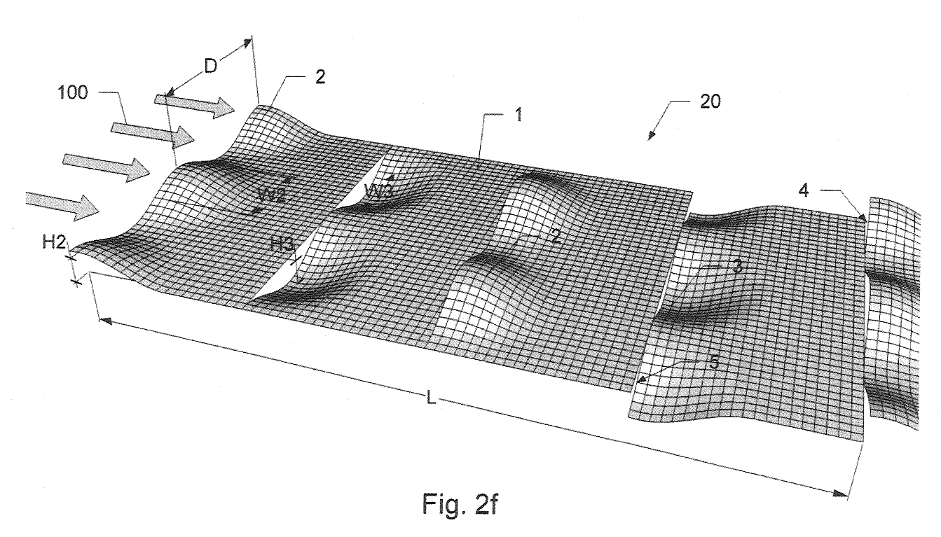

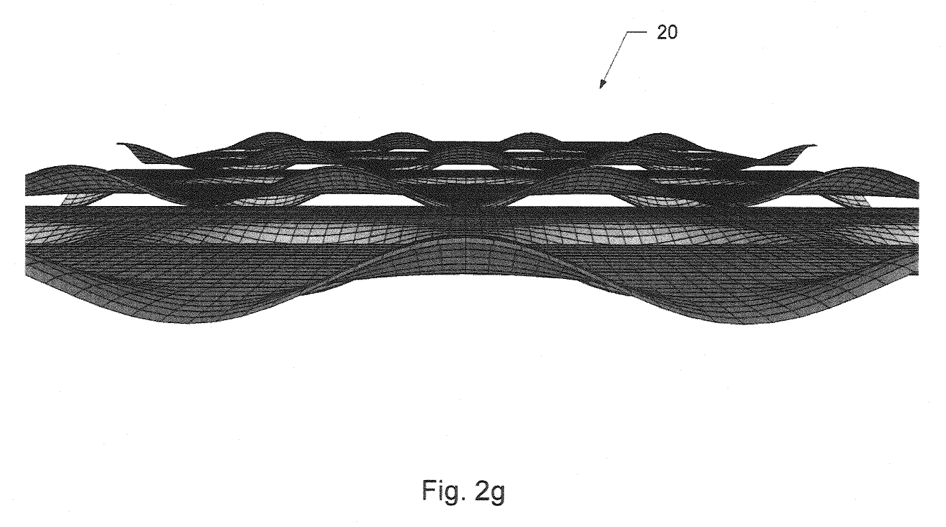

FIG. 2a shows a schematic plan view of a first spacer according to the invention;

FIGS. 2b-c show perspective views of the spacer of FIG. 2a;

FIGS. 2e-g show perspective views of a second spacer according to the invention;

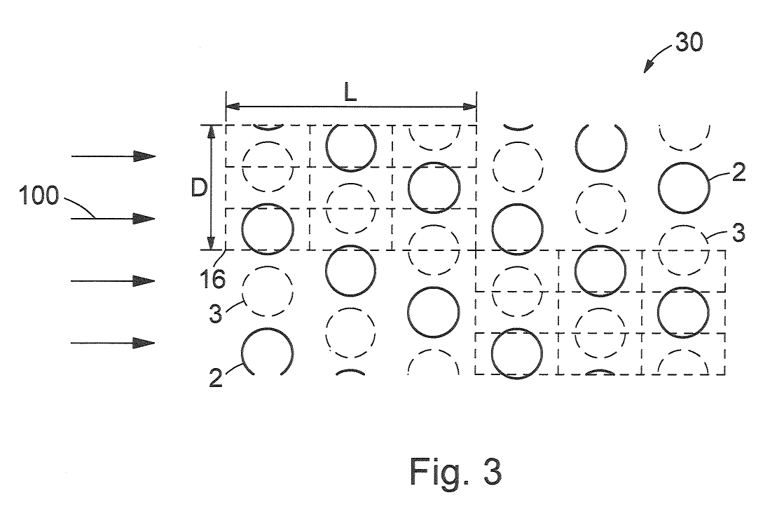

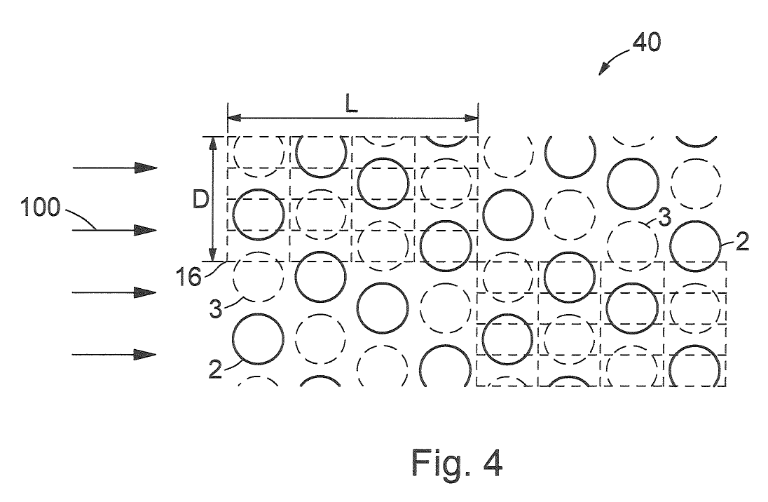

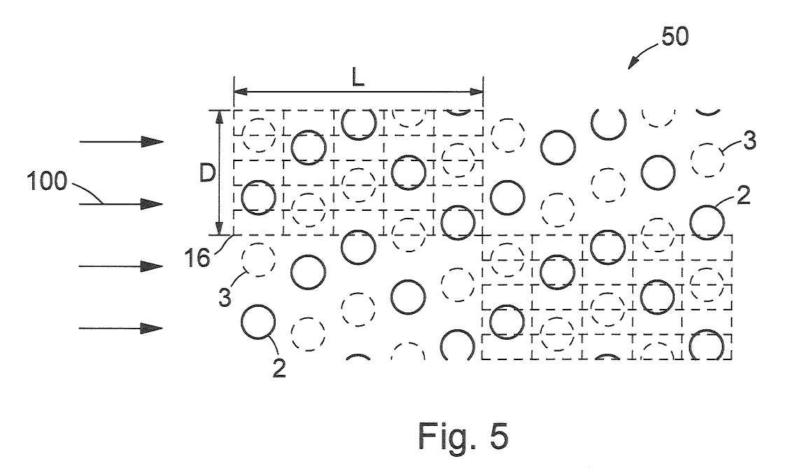

FIGS. 3-5 show plan views of further embodiments according to the invention of spacers;

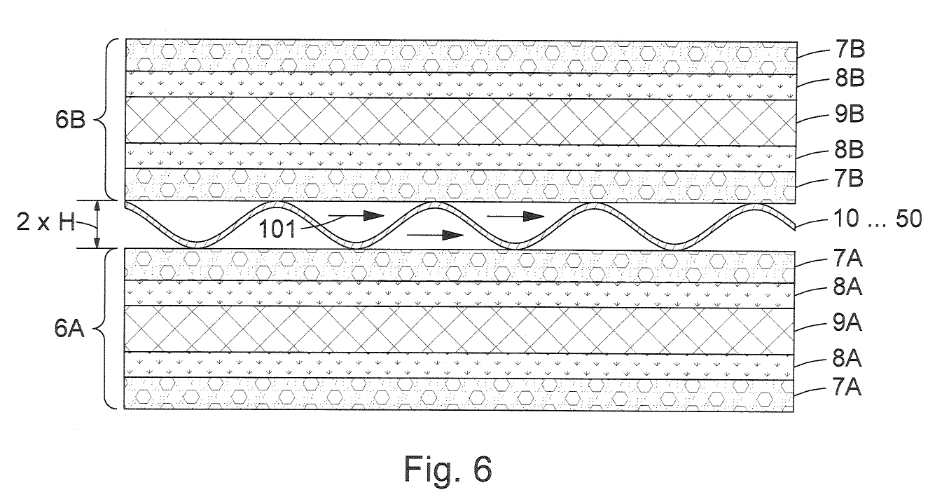

FIG. 6 shows a sectional view of two filter elements having a spacer in between; and

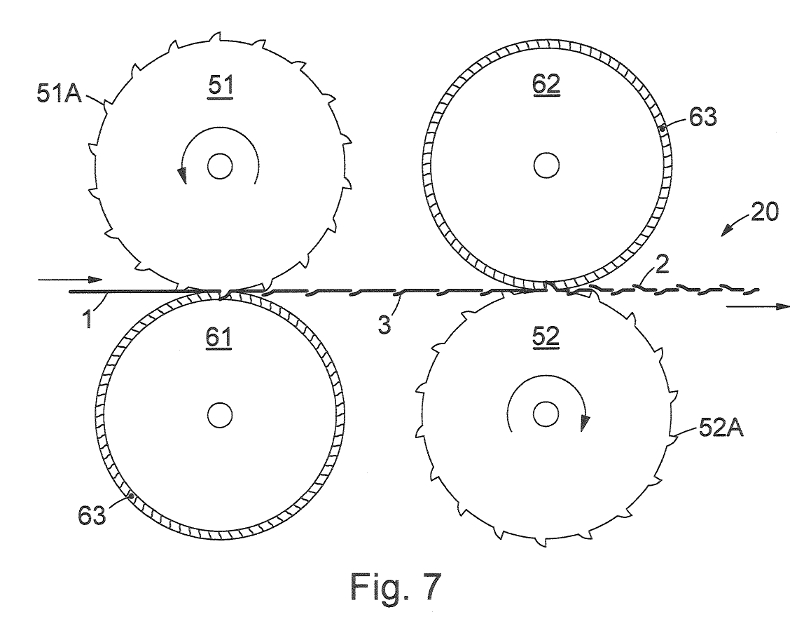

FIG. 7 shows a device for producing the feed spacer.

FIG. 1 shows a net-type diamond spacer customary in the prior art which is arranged as shaper between each two flat filter elements of a filtration device. A filtration device comprises a multiplicity of filter elements, wherein the totality of the passages bordered by each two adjacent filter elements form the flow for the overflow of the filter elements with feed (crossflow). The meshes of the diamond spacer are formed by two layers of crossed filaments and are rectangular or lozenge-shaped. A diamond spacer is oriented in the filtration device in such a manner that the filaments run slanted to a predetermined axis 100, wherein the predetermined axis 100 substantially corresponds to the flow axis of the feed in the flow, i.e. to the flow vector of the crossflow.

Diamond spacers are customarily produced by extrusion from a thermoplastic material such as polypropylene or nylon. The extruder used for this purpose typically has two concentrically arranged ring dies for the two crossed filament layers.

FIG. 2a shows, inter alia, a schematic plan view of a first spacer 10 according to the invention. The spacer comprises a film-type or net-like flat material 1 which, on at least one side, has convex support elements 2 which are arranged on the surface of the flat material 1 in a periodic pattern. In a preferred development of the invention, the spacer 10, on each of the two sides of the flat material 1, has convex support elements 2, 3 which can be formed in a dome shape. “Dome shape” in this case denotes a support element 2, 3 which is formed to be solid or shell-like, and the contour of which is substantially identical to the contour of a segment of a sphere or of an ellipsoid of rotation. An axis predetermined by direction arrow 100 is oriented in parallel to a base surface 11 of the spacer 10. On installation of the spacer 10 into a filtration device, the axis 100 is oriented substantially parallel to the flow axis of the feed (crossflow) or of the permeate. The base surface 11 is shown dashed in a lower sectional view of FIG. 2a and runs through the planar, non-deformed flat material 1.

In addition to the plan view, FIG. 2a shows two sectional views along a line Y-Y parallel to the axis 100 and also a line X-X perpendicular to the axis 100. The surface contour of the spacer 10 according to the invention is clear from these sectional views. The support elements 2, 3 project perpendicularly from the base surface 11 of the spacer 10, wherein the crest or summit of each support element 2, 3 has a spacing or height H2, H3 based on the base surface 11. In embodiments according to the invention which have support elements 2 and 3 on both sides of the flat material 1, the height H2 and H3 of the support elements 2 and 3 can be identical or different from one another. The hatching 12 in FIG. 2a indicates that the support elements 2 and/or 3 can be constructed so as to be solid. The support elements 2, 3 have a width at half maximum W2, W3, which corresponds to the maximum diameter, measured perpendicularly to the axis 100 at a distance or a height of ½·H2 or ½·H3 from the base surface 11.

FIG. 2c shows a perspective partial view of the spacer in which the dimensions L, D of the unit cell and also the width at half maximum W2, W3 and the height H2, H3 of the support elements 2, 3 are shown clearly.

The periodic pattern in which the support elements 2 are arranged is made up of rectangular unit cells having the dimensions L in parallel and D perpendicular to the predetermined axis 100. Within the individual unit cell L, D, at least two support elements 2 are arranged in such a manner that the perpendicular of a fixed point, in particular of the summit of the dome-shaped surface thereof onto the base surface 11 of the spacer 10, lies on predetermined positions. In the spacer 10 shown in FIG. 2a having N=2 support elements 2 per unit cell L, D, the support elements 2 are arranged in such a manner that the spacing thereof from an origin 16 of the unit cell L, D perpendicular to the axis 100 has an amount of ¼·D and ¾·D, corresponding to values of (2·j−1)·D/(2·N) where N=2 and j=1 and 2.

In embodiments according to the invention which have support elements 2 and 3 on both sides of the flat material 1, the support elements 2 and 3 are in each case arranged in a periodic pattern as described above, wherein the origin of the coordinates of the respective pattern having the support elements 3 relative to the origin of the coordinates of the respective pattern having the support elements 2 situated on the opposite side of the spacer can be congruent or offset from one another. In the case of an offset, the offset vector of the support elements 3 relative to the support elements 2 arranged on the opposite side of the spacer 10 is selected in such a manner that the overlap of the support elements 3 with the support elements 2 is as small as possible. In the spacer 10 shown in FIG. 2a having N=2 support elements, advantageously an offset vector having a component of the value zero perpendicular to the axis 100 and 1/3.2·L parallel to the axis 100 is selected. In all other cases in which N is greater than or equal to 3 and less than/equal to 1000, expediently an offset vector having a component of the value D/2 perpendicular to the axis 100 and zero parallel to the axis 100 is selected.

Owing to the equidistant arrangement of the support elements 2 in a spacing of D/N—in the case of the arrangement according to FIG. 2a in a spacing of D/2—perpendicular to the axis 100 in combination with the convex shape, the support elements 2 form a two-dimensional periodic grating of obstacles at which the feed flow (crossflow) flowing substantially in the direction of the axis 100 is deflected. The surface of the convex, in particular dome-shaped support elements 2 preferably has a continuous, more or less stream-line contour, and so the development of vortices and also back-up and dead zones is substantially avoided. In the perspective view of FIG. 2b, the flow round support elements 2 and 3 is illustrated schematically by means of direction arrows. It is clear therefrom that the spacer 10 has a continuous surface which is substantially open for the feed flow. Secondly, by the regular arrangement of the support elements 2 perpendicular to the axis 100 and the packing of each two adjacent rows of support elements it is ensured that along the axis 100 no open passage is formed, through which feed can flow off unimpeded by any deflection. This fact is made further clear in FIG. 2d which gives a perspective view of the spacer 10 with direction of view along the axis 100, i.e. in the direction of the feed flow.

According to the invention, the N=2 support elements of the unit cell L, D can be arranged adjacently perpendicularly to the axis 100, i.e. that their spacing from the origin 16 of the unit cell L, D in the direction of the axis 100 is identical. With this arrangement, a uniform deflection of the feed flow is already achieved. However, according to the invention, the arrangement shown in FIGS. 2a-d is preferred, in which the two support elements 2 and 3 in the unit cell are offset in the direction of the axis 100 by the distance L/N—in the case of the arrangement according to FIG. 2a in a spacing of L/2. In this arrangement, the two support elements 2 are situated at positions having the coordinates L/4 and L·¾ parallel to the axis 100 and D/4 and D·¾ perpendicular to the axis 100.

FIGS. 2e to 2g show a spacer 20 as a development 20 according to the invention of the spacer of FIG. 2a. In the spacer 20, the support elements 2, 3 have passages 4, 5 through the flat material 1. The passages 4, 5 make possible a feed flow or permeate flow from the top to the bottom of the spacer 20 and vice versa. The cross sectional surface of the passages 4, 5 runs substantially perpendicularly to the axis 100. A feed flow or permeate flow which flows along the top or bottom side of the spacer 20 in the direction of the axis 100 along a flow line that passes through a passage 4 or 5 is deflected to the bottom or top side of the spacer 20. This fact is made clear in FIG. 2e by corresponding direction arrows. The invention covers spacers which have support elements 2 or 3 respectively on one or both sides. Accordingly, the support elements and/or 3, independently of one another, can be furnished with passages 4 and/or 5. For producing a spacer 20 having passages 4, 5, as flat material 1, preferably a film made of a metallic or a thermoplastic material is used.

In all spacers according to the invention, the dimensions of the respective unit cell L and D, independently of one another, are 2 to 1000 mm. In order that the feed flow is deflected to a sufficient extent, the widths at half maximum W2, W3 must not fall below a certain minimum size. In the spacers 10 and 20 shown in FIGS. 2a to 2g, each of which have two support elements 2, 3 in the unit cell, the widths at half maximum W2, W3 have according to the invention a value between 0.1·D to 0.6·D, preferably 0.2·D to 0.5·D, and in particular 0.2·D to 0.4·D. Preferably, the support elements 2, 3, independently of one another, have widths at half maximum W2 and W3 in a range from 0.3 to 10 mm.

The heights H2, H3 of the support elements 2, 3 are 0.1 to 4 mm, in particular 0.6 to 2.0 mm, in each case based on the base surface 11 of the spacers 10 and 20, respectively.

FIGS. 3 to 5 show further embodiments according to the invention of spacers 30, 40 and 50 having N=3, N=4 and N=5 support elements 2 per unit cell L, D. In the same manner as the spacers 10 and 20 described above in connection with those in FIGS. 2a to 2g, the spacers 30, 40 and 50 can have support elements 2 or 3 respectively on one or both sides, wherein the support elements 2 and/or 3 are optionally furnished with passages 4 and/or 5.

The positions or spacings in which the support elements 2, 3 of the spacers 30, 40 and 50 are arranged in the respective unit cell L, D—based on the origin 16—have, in the direction perpendicular to the axis 100, a size of (2·j−1)·D/(2·N) where j is integral and 1≦j≦N, wherein each value j=1, . . . , N occurs exactly once. The correspondingly determined spacings perpendicular to the axis 100 are given in Table 1.

TABLE 1
Spacing of the support elements 2 (3) from the origin
16 of the unit cell perpendicular to the axis 100

| | #1 | #2 | #3 | #4 | #5 |
|---|---|---|---|---|---|
| j | 1 | 2 | 3 | 4 | 5 |
| N = 3 | 1/6 · D | 3/6 · D | 5/6 · D | — | — |
| N = 4 | 1/8 · D | 3/8 · D | 5/8 · D | 7/8 · D | — |
| N = 5 | 1/10 · D | 3/10 · D | 5/10 · D | 7/10 · D | 9/10 · D |

In Table 1, the support elements 2 of the unit cell L, D are consecutively numbered with #1, #2, #3, . . . . According to the invention, all support elements 2 of the unit cell L, D, in the direction of the axis 100, can have the same spacing, for example zero or L/(2·N), from the origin 16 of the unit cell. Accordingly, the support elements 2 can be arranged in a pattern of lines oriented perpendicular to the axis 100 and running in parallel to one another at a spacing L. However, according to the invention a pattern is preferred in which the support elements of the unit cell L, D are arranged in the direction of the axis 100 in spacings of (2·i−1)·L/(2·N) where i is integral and 1≦i≦N to the origin 16 of the unit cell, wherein each i=1, . . . , N occurs exactly once. In such a pattern or grating, the support elements 2 or 3 form an arrangement of equidistant obstacles or deflection points not only for flows parallel to the axis 100 but also for flows perpendicular to the axis 100. An example of correspondingly calculated spacings parallel to the axis 100 is given in Table 2.

TABLE 2
Spacing of the support elements 2 (3) from the origin
16 of the unit cell parallel to the axis 100

| | #1 | #2 | #3 | #4 | #5 |
|---|---|---|---|---|---|
| i | 1 | 2 | 3 | 4 | 5 |
| N = 3 | 1/6 · L | 3/6 · L | 5/6 · L | — | — |
| N = 4 | 1/8 · L | 3/8 · L | 5/8 · L | 7/8 · L | — |
| N = 5 | 1/10 · L | 3/10 · L | 5/10 · L | 7/10 · L | 9/10 · L |

In a pattern predetermined according to Table 1 and 2, the support elements 2 are arranged along one of the two diagonals of the unit cell L, D. According to the invention, however, arrangements deviating therefrom are preferred in which, for at least two support elements 2, the coordinate indices i and j are different from one another (i≠j) and for at least two support elements 2 the sum of their coordinate indices i+j is different from N+1 (i+j≠N+1). If the above condition is met, not all support elements 2 are on one of the diagonals of the unit cell L, D. An example of correspondingly selected spacings is given in Table 3.

TABLE 3
Spacing of the support elements 2 (3) from the origin 16 of the unit cell

| | #1 | | #2 | | #3 | | #4 | | #5 | |
|---|---|---|---|---|---|---|---|---|---|---|
| i/j | 1 | 1 | 2 | 3 | 3 | 2 | 4 | 4 | 5 | 5 |
| N = 3 | 1/6 · L | 1/6 · D | 3/6 · L | 5/6 · D | 5/6 · L | 3/6 · D | — | — | — | — |
| N = 4 | 1/8 · L | 1/8 · D | 3/8 · L | 5/8 · D | 5/8 · L | 3/8 · D | 7/8 · L | 7/8 · D | — | — |
| N = 5 | 1/10 · L | 1/10 · D | 3/10 · L | 5/10 · D | 5/10 · L | 3/10 · D | 7/10 · L | 7/10 · D | 9/10 · L | 9/10 · D |

In the example of Table 3, the coordinate indices i and j of the second #2 and the third #3 support element 2 are different from one another. The spacers 30, 40, 50 shown in FIGS. 3 to 5 having N=3, 4 and 5 support elements 2 or 3 in the unit cell L, D have the pattern preferred according to the invention according to Table 3, according to which not all support elements 2 or 3 lie on one of the diagonals of the unit cell L, D. This arrangement has the particular property that it does not have a preferred direction—for example along one of the diagonals of the unit cell L, D—having an open passage or channel through which the feed stream can flow, without meeting a support element 2, 3 and being deflected.

According to the invention, arrangements are additionally preferred in which for at least two support elements 2 of the unit cell L, D, the coordinate indices i and j are different from one another (i≠j), for at least two support elements 2 the sum of their coordinate indices i+j is different from N+1 (i+j≠N+1), for at least one support element 2 the coordinate indices i and j are equal (i=j) and for at least one support element 2 the sum of the coordinate indices i+j is equal to N+1 (i+j=N+1). If the above conditions are met for the individual case, then in each case at least one support element 2 lies on each of the two diagonals of the unit cell L, D. These conditions may only be met for N≧4. An example of correspondingly chosen spacings is given in Table 4.

TABLE 4
Spacing of the support elements 2 (3) from the origin 16 of the unit cell

| | #1 | | #2 | | #3 | | #4 | | #5 | |
|---|---|---|---|---|---|---|---|---|---|---|
| i/j | 1 | 4 | 2 | 2 | 3 | 3 | 4 | 1 | — | — |
| N = 4 | 1/8 · L | 7/8 · D | 3/8 · L | 3/8 · D | 5/8 · L | 5/8 · D | 7/8 · L | 1/8 · D | — | — |
| i/j | 1 | 5 | 2 | 3 | 3 | 1 | 4 | 4 | 5 | 2 |
| N = 5 | 1/10 · L | 9/10 · D | 3/10 · L | 4/10 · D | 5/10 · L | 1/10 · D | 7/10 · L | 7/10 · D | 9/10 · L | 3/10 · D |

All spacers 10, 20, 30, 40, 50 of the present invention have the advantage that with a minimal surface density of support elements 2, 3, a complete deflection of the feed flow is achieved. The flow deflection contributes decisively to reducing the polarization layer upstream of the filtration membrane and thereby increasing the filtration efficiency. Accordingly, the present invention provides spacers having an optimum ratio of filtration efficiency to resistance to flow.

When used as permeate spacers, the spacers according to the invention 10, 20, 30, 40, 50 have the advantage that with a low surface density of support elements 2, 3, a uniform support of the filtration membranes can be achieved avoiding rectilinear channels or recesses on which the filtration membranes bend.

The low resistance to flow of the spacers according to the invention is decisively achieved by the arrangement of the support elements according to the above described two-dimensional periodic pattern. The convex, in particular dome shape of the support elements contributes in a small extent to reducing the resistance to flow. In alternative embodiments of the invention, the support elements can also be configured as cylinders, quadrahedrons, tetrahedrons or spheres. Dome-shaped support elements, however, have the following advantages:
the spacer has a substantially continuous surface contour without edges; therefore the tendency to blockage is low and the spacer is easy to clean;
owing to the dome shape, the localized mechanical pressure loading of the sensitive filtration membrane is low; and
spacers having dome-shaped support elements are simple and inexpensive to produce by embossing or deep drawing a thermoplastic film.

FIG. 6 shows schematically a sectional view of a spacer 10, 20, 30, 40 or 50 according to the invention arranged between two filter elements 6A and 6B. The filter elements 6A and 6B are for example made up in multilayers of upper and lower membranes 7A, 8A or 7B, 8B, between which is situated a permeate spacer 9A or 9B. The membranes generally consist of a polymeric membrane layer 7A or 7B which can be deposited in a known manner by phase inversion on a porous support nonwoven 8A or 8B. As indicated by the directional arrows 101, the feed stream flows according to the crossflow principle tangentially to the surface of the membranes 7A and 7B in the passage bordered by the two adjacent filter elements 6a and 6B. The feed stream is multiply deflected by the spacers 10, . . . , 50. Without this forced deflection, the feed stream would flow more or less in a laminar fashion over the polarization layer formed immediately upstream of the membranes 7A and 7B without giving rise to the mixing of feed and retentate necessary for mass transport, which retentate is enriched owing to the concentration gradient in the polarization layer.

Alternatively to the configuration shown in FIG. 6, one or more spacers 10, . . . , 50 can form an integral component of the filtration membrane 6A and/or 6B. Depending on whether used as feed spacer and/or permeate spacer, for this purpose the front side and/or the rear side of the filtration membranes 6A and/or 6B can be furnished with support elements in one of the above described patterns.

In another expedient embodiment of the invention, in each case two filtration membranes are connected to one another by bonded joints, wherein the bonded joints are arranged in a pattern according to any one of claims 1 to 8. The bonded joints serve as support elements which firstly mechanically stabilize the filtration membranes and secondly deflect the flow of a fluid that is to be purified or has been purified. The preferably point-form bonded joints can be arranged in the flow and/or in the permeate chamber of a filtration device. In the first case (flow), the top sides or the membrane layers of in each case two adjacent filtration membranes are joined together by bonded joints. In the second case (permeate chamber), the bottom sides or the support nonwovens of in each case two adjacent filtration membranes are joined together by bonded joints.

FIG. 7 shows schematically an example of a device for producing a spacer 20 according to the invention which has on both sides support elements 2, 3 with passages. For this purpose a flat material 1, such as a film made of a metallic or polymeric material, preferably of a thermoplastic, is passed between two roller pairs 51, 61 and 62, 52. The shell surface of one roller 61 or 62 of each roller pair is furnished with a coating of an elastic material 63, for example rubber of Shore hardness D, and acts as counter roller for an embossing roller 51 or 52. The embossing rollers 51, 52, on their shell surfaces, bear embossing elements 51A, 52A, preferably spike-like appendages made of a metallic material such as steel. The embossing elements 51A, 52A have a dome shape having a curved cutting edge and are arranged in one of the above described patterns according to the invention. On passing through the gap of one of the roller pairs 51, 61 or 62, 52, the embossing elements 51A and 52A are pressed into the flat material 1. The roll of the roll pairs are preloaded against one another in such a manner that the flat material 1 is opened by the cutting edge of the embossing elements 51A and 52A and formed to give support elements 2 and 3 with passages.

The method described with reference to FIG. 7 can be varied in many ways. Depending on the construction of the spacer with support elements 2 and/or 3 provided on one or both sides, one or two roller pairs are used. Dome-shaped support elements 2, 3 with a closed contour without passage are obtainable by corresponding shaping of the embossing elements 51A, 52A. When a flat material 1 made of a thermoplastic polymer is used, the embossing is expediently carried out at an elevated temperature, in particular above the softening point (TG) of the thermoplastic polymer.

In addition to the embossing, in addition further methods customary in the prior art such as deep drawing, injection molding or extrusion are provided. According to the invention, injection molding and extrusion are taken to mean methods in which the support elements are generated by localized material deposition. In addition, compression methods as are used, for example, for OLED, and also screenprinting or a photolithographic structuring come into consideration.

As mentioned at the outset, it is provided, inter alia, that the spacer according to the invention forms an integral component of a filtration membrane. Depending on whether used as feed spacer and/or permeate spacer, for this purpose the front side, i.e. a polymeric membrane layer deposited by phase inversion or a stretched polymer film and/or the rear side, i.e. the support nonwoven or support woven fabric, structures the filtration membrane. For structuring a filtration membrane, a stretched polymer film or a support nonwoven or support woven fabric, depending on process suitability and economics, known methods such as mechanical and/or thermal embossing, deep drawing or printing are used. For example, a support nonwoven or support woven fabric is structured by deep drawing and then a polymeric membrane layer is deposited on the structured support nonwoven/woven fabric by phase inversion. In a similar manner, a stretched polymeric membrane film is structured by mechanical embossing and a support nonwoven is then laminated thereto. In order to furnish a polymeric membrane layer deposited on a support nonwoven by phase inversion with support elements according to the invention made of a polymeric material, preferably a printing method is used. In the printing method, an industrially suitable inkjet printer using a low-viscosity dispersion of a polymeric material is used. Alternatively thereto, the membrane layer can be printed on a printing machine with transfer or gravure rollers using a high-viscosity dispersion of a polymeric material. In addition, it is provided to apply the support elements by screenprinting.

1. A spacer for devices for gas separation, reverse osmosis, forward osmosis, dialysis, micro-, ultra- or nanofiltration comprising a flat material which has a multiplicity of convex support elements having a base area of 0.03 to 600 mm² on one or both surfaces and which are arranged on the flat material in a pattern having one or more periodically repeating unit cells containing 2 to 100 000 support elements having a surface coverage of 0.1 to 20%.

2. The spacer as claimed in claim 1, wherein the surface coverage of the support elements on the flat material is in the range from 0.1 to 10%.

3. The spacer as claimed in claim 1, wherein the unit cell contains 3 to 10 000 support elements.

4. The spacer as claimed in claim 1, wherein any straight line which runs in a predetermined direction or axis on one or both surfaces of the flat material intersects the base area of at least one support element on a section having a length of 2 to 1000 mm.

5. The spacer as claimed in claim 1, wherein the support elements are arranged in a pattern having one or more periodically repeating parallelogram-shaped or rectangular unit cells having a first and second side D and L which, independently of one another, have a length of 2 to 1000 mm, wherein the unit cell contains 2 to 100 000 support elements, and N support elements where N is integral and 2≦N≦1000, based on the origin of the unit cell and in the direction of the side D are arranged at a spacing of greater than D·(2·j−1)/(2·N)−0.1·D/N and less than D·(2·j−1)/(2·N)+0.1·D/N where j is integral and 1≦j≦N and each value j=1, . . . , N occurs exactly once.

6. The spacer as claimed in claim 5, wherein the N support elements based on the origin of the unit cell and in the direction of the side L are arranged at a spacing of greater than L·(2·i−1)/(2·M)−0.1·L/M and less than L·(2·i−1)/(2·M)+0.1·L/M where M, i are integral, 2≦M≦1000 and 1≦i≦M.

7. The spacer as claimed in claim 6, wherein each value i occurs exactly once.

8. The spacer as claimed in claim 6, wherein for at least two of the N support elements, the values i and j are different from one another (i≠j) and for at least two support elements the sum i+j is different from N+1 (i+j≠N+1).

9. The spacer as claimed in claim 1, wherein the support elements have a dome shape.

10. The spacer as claimed in claim 5, wherein the support elements, in the direction of the side D, have a width at half maximum W2 and W3 which is in the range from 0.2·D/N to 1.2−D/N, or in that the support elements in the direction of the side D, have a width at half maximum W2 and W3 of 0.3 to 10 mm.

11. The spacer as claimed in claim 1, wherein the support elements have a height H from 0.1 to 4 mm, in each case based on a base area of the spacer.

12. The spacer as claimed in claim 1, wherein the support elements have passages having a cross section which is arranged substantially perpendicularly to a predetermined axis and the passages join the opposite sides of the spacer.

13. The spacer as claimed in claim 1, wherein said spacer is constructed in a one-piece manner, and has a thickness of 0.1 to 2 mm.

14. The spacer as claimed in claim 1, wherein said spacer has a hydrophobic coating.

15. A method for producing a spacer as claimed in claim 1, said method comprising forming support elements in a band-shaped flat material made of a metallic, textile or polymeric material, using at least one embossing roller and the at least one embossing roller has shaping embossing elements which are arranged in a periodical pattern having a parallelogram-shaped or rectangular unit cell having a first and second side D and L which, independently of one another, have a length of 2 to 1000 mm, the unit cell contains 2 to 100 000 support elements, and N support elements where N is integral and 2≦N≦1000, based on the origin of the unit cell and in the direction of the side D are arranged at a spacing of D·(2·j−1)/(2·N) where j is integral and 1≦j≦N and each value j=1, . . . , N occurs exactly once.

16. A device for gas separation, reverse osmosis, forward osmosis, dialysis, micro-, ultra- or nanofiltration, comprising filtration membranes and one or more spacers as claimed in claim 1 arranged in a flow and/or in a permeate chamber of the device.

17. The device as claimed in claim 16, wherein the spacer is an integral component of the filtration membranes.

18. The spacer as claimed in claim 2, wherein the surface coverage of the support elements on the flat material is in the range from 1 to 8%.

19. The spacer as claimed in claim 2, wherein the surface coverage of the support elements on the flat material is in the range from 1 to 5%.

20. The spacer as claimed in claim 3, wherein the unit cell contains 10 to 1000 support elements.

21. The spacer as claimed in claim 3, wherein the unit cell contains 20 to 100 support elements.

22. The spacer as claimed in claim 5, wherein N is 3≦N≦1000.

23. The spacer as claimed in claim 5, wherein N is 10≦N≦200.

24. The spacer as claimed in claim 5, wherein N is 20≦N≦100.

25. The spacer as claimed in claim 6, wherein M is equal to N (M=N).

26. The spacer as claimed in claim 8, wherein for at least one support element the values i and j are equal (i=j) and for at least one support element the sum of the values i and j is equal to N+1 (i+j=N+1).

27. The spacer as claimed in claim 10, wherein the support elements have a width at half maximum W2 and W3 which is in the range from 0.4·D/N to 1.0·D/N.

28. The spacer as claimed in claim 10, wherein the support elements have a width at half maximum W2 and W3 which is in the range from 0.4 to 0.8·D/N.

29. The spacer as claimed in claim 11, wherein the support elements have a height H from 0.6 to 2.0 mm.

30. The spacer as claimed in claim 13, wherein the flat material is a film or a knitted fabric made of one or more polymeric, textile or metallic materials.

31. The spacer as claimed in claim 13, wherein the flat material is polyvinylsiloxane.

32. The method for producing a spacer as claimed in claim 15, wherein 3≦N≦1000.

33. The method for producing a spacer as claimed in claim 15, wherein 10≦N≦200.

34. The method for producing a spacer as claimed in claim 15, wherein 20≦N≦100.

35. The device as claimed in claim 16, wherein the side L of the unit cell of the spacers is oriented substantially parallel to a flow axis of the flow and/or permeate chamber.
